(19) United States
(12) Patent Application Publication
(10) Pub. No.: US 2007/0011130 A1
(43) Pub. Date: Jan. 11, 2007

(54) Method for browsing contents using page storing file

(76) Inventor: Shinji Yamabuchi, Tokyo (JP)

Correspondence Address: MORRISON & FOERSTER LLP, 425 MARKET STREET, SAN FRANCISCO, CA, 94105-2482, US

(21) Appl. No.: 10/557,316

(22) PCT Filed: May 28, 2004
(86) PCT No.: PCT/JP04/07794

§ 371 Date: Nov. 18, 2005

(30) Foreign Application Priority Data
Jun. 3, 2003 (JP) 2003-157683

(51) Int. Cl. G06F 17/30

(52) U.S. Cl. 707/1

(57) ABSTRACT

There is provided a method of browsing contents on a network in an offline mode of a terminal device. The method includes receiving a request for an object, reading out the requested object from a storing file, which stores at least one object obtained from the network and has a predetermined file format, by using management information including relationship between location information locating the requested object on the network and a file name of the storing file containing the requested object, and displaying the requested object read out from the storing file.

### FIELD OF THE INVENTION

The present invention relates to a browser used for browsing contents, and particularly to browsing of contents in an offline mode.

### BACKGROUND OF THE INVENTION

Recently, with the widespread use of portable devices, such as a PDA (personal digital assistant), a mobile phone and etc., as a background, user demands for browsing Web pages in an offline mode on the portable device are now increasing. The reason is that a user wants to view Web pages even if a user's portable device is in an environment in which the device can not be connected to a network (i.e., in the offline mode). Another reason is that the user wants to view Web pages after the user has been downloaded the Web page into the user's portable device, without concern for connection fees.

As used herein, terms indicated below have the following meanings.

“Web page”: the whole content which is to be displayed when the user designates a URI (Uniform Resource Identifier). That is, the whole content which can be viewed on a screen by scrolling the content.

“Object”: data which can be designated on a network by a URI. That is, the object includes an HTML (Hypertext Markup Language) document, an image file, an audio data and etc.

“Anchor selection”: to select one of links represented, for example, by an anchor tag <A>˜</A>.

Off line browsing of Web pages can be attained by caching the Web pages downloaded through the network. A conventional browser has the function of caching Web pages browsed by a user into storage devices such as a memory or a hard disc drive. Since the cached Web pages can be displayed on a screen without connecting the user's device to the network, the offline browsing can be attained by using the function of caching. Each of Japanese Patent Provisional Publication No. HEI 4-219839 and Japanese Patent No. 2976896 discloses a configuration for caching data obtained through a network into local files.

Another method for offline browsing is to store a Web page, downloaded through the network, as a file. One of known formats for storing the Web page is an “mht” format. By utilizing the mht format, data of one Web page is encoded in accordance with MIME (multipurpose internet mail extensions) and is stored as a single file. Therefore, the user can browse a Web page in the offline mode after the user saves the Web page as a mht format file.

As described above, the offline browsing can be attained by utilizing the function of caching that the browser has or by storing a Web page as a mht format file.

However, with regard to the function of caching, there is a problem that a time period over which cached data (Web pages) is saved depends on settings on the browser, and the cached data is abandoned after the time period according to the settings on the browser has passed.

In addition, there is a case where an expiration date for caching is designated in a response from a server or an expiration date for caching is defined in a description in obtained contents. Further, there is a case where the caching is disapproved in the response from the server or in the description in the obtained contents. In such a case, the offline browsing using cached contents can not be performed.

With regard to a method of storing a Web page as a mht file, although the above mentioned problem in the case of the caching does not arise because the mht file is not automatically deleted, the following problem arises. That is, when a user displays a Web page stored as a mht format file on a screen, if the user selects one of links (i.e., anchor tags), a transition from the current Web page being displayed on the screen to the user selected Web page (URI) can not be attained because the mht format file is not designed to enable a transition among Web pages stored in different mht files. This problem arises even if a mht format file containing the user selected link (URI) exists in the user's device.

### SUMMARY OF THE INVENTION

The present invention is advantageous in that it provides a method which enables to browse Web pages in an offline mode as if a user browses Web pages in an online mode.

According to an aspect of the invention, there is provided a method of browsing contents on a network in an offline mode of a terminal device. The method includes receiving a request for an object, reading out the requested object from a storing file, which stores at least one object obtained from the network and has a predetermined file format, by using management information including relationship between location information locating the requested object on the network and a file name of the storing file containing the requested object, and displaying the requested object read out from the storing file.

With this configuration, a transition from a Web page to another Web page selected by, for example, an anchor selection can be attained in the offline mode. That is, the offline browsing is performed as if the terminal device is in the online mode.

Optionally, the storing file may contain a plurality of objects. In this case, the management information may include for each of the plurality of objects:

(a) the location information of a target object;

(b) the file name of the storing file including the target object;

(c) address information of the target object in the storing file.

Still optionally, the reading out the requested object from the storing file may include searching the management information to obtain the file name of the storing file containing the requested object and to obtain the address information of the requested object, and reading out the requested object from the searched storing file using the obtained file name and the address information.

According to another aspect of the invention, there is provided a method of browsing contents on a network in an offline mode of a terminal device. The method includes receiving a request for an object designated by a URI, reading out the requested object from a storing file, which stores a Web page containing at least one object, by using management information which is used to search for the requested object in the storing file using the URI as a keyword, and displaying the requested object read out from the storing file.

With this configuration, a transition from a Web page to another Web page selected by, for example, an anchor selection can be attained in the offline mode. That is, the off line browsing is performed as if the terminal device is in the online mode.

Optionally, the storing file may contain a plurality of objects. In this case, the management information may include for each of the plurality of objects:

(a) the URI of a target object;

(b) a file name of the storing file including the target object; and

(c) address information of the target object in the storing file. Further, in this case, the reading out the requested object from the storing file may include searching the management information to obtain the file name of the storing file containing the requested object and to obtain the address information of the requested object, and reading out the requested object from the searched storing file using the obtained file name and the address information.

Still optionally, the management information may include for each of the plurality of objects:

(d) one of a latest update time of the target object and an acquisition time of the target object. In this case, the reading out the requested object from the storing file may include: selecting latest one from objects having the same URI corresponding to the requested object using the management information if two or more objects having the same URI corresponding to the requested object are stored in one or more storing files; and reading out the latest one from the storing file using the file name and the address information concerning the latest one.

Alternatively, the management information may include for each of the plurality of objects: (d) one of a latest update time of the target object and an acquisition time of the target object. In this case, the reading out the requested object from the storing file may include: if two or more objects having the same URI corresponding to the requested object are stored in one or more storing files, displaying the file name and/or the acquisition time regarding the two or more objects so that a user can selects one of the two or more object; and reading out one of the two or more objects selected by the user from the storing file using the file name and the address information concerning the object selected by the user.

Alternatively, the management information may include for each of the plurality of objects: (d) one of a latest update time of the target object and an acquisition time of the target object. In this case, the reading out the requested object from the storing file may include: if two or more objects having the same URI corresponding to the requested object are stored in one or more storing files, selecting one of the two or more objects, wherein the one of the two or more objects has the acquisition time nearest to the acquisition time of an Web page previously displayed before the requested object currently requested is designated by a user on the previously displayed Web page; and reading out the selected object from the storing file using the file name and the address information concerning the selected object.

In a particular case, the management information may further include for each of the plurality of objects: (e) verification data which is used to verify that the storing file including the target object is not changed from a time when the storing file containing the target object is initially registered. In this case, the reading out the requested object from the storing file may include reading out the requested object only when it is confirmed that the verification data corresponding to the requested object is consistent with the storing file containing the requested object.

Optionally, the verification data may include at least one of a file size, a time stamp, a checksum and a CRC concerning the storing file.

Optionally, the verification data may includes a message digest including one of an MD5 and SHA-1.

In a particular case, the URI of the requested object may be inputted by a user by a letter input through use of a user interface device.

In a particular case, the URI of the requested object may be designated by a user by an anchor selection.

In a particular case, the storing file may contain a single object, and the management information may include for each of the plurality of objects:

(a) the URI of a target object; and

(b) a file name of the storing file including the target object.

Optionally, the method may include creating or updating the management information when the Web page is stored as the storing file.

Optionally, the method may include creating or updating the management information based on the storing file being stored when the terminal device changes from an online mode to the offline mode.

Optionally, the method may include creating or updating the management information when it is found that the storing file having the searched file name is not exist in actuality.

Optionally, the method may include: detecting file operation regarding the storing file; and creating or updating the management information in accordance with a type of the file operation. The file operation may include at least one of addition, update and deletion of the storing file.

In a particular case, the method may include when it is detected that the verification data corresponding to the requested object is not consistent with the storing file containing the requested object, updating the management information for the storing file which is not consistent with the verification data.

Optionally, the management information may be stored on a memory in the terminal device.

Optionally, the management information may be stored as a file in a file device provided in the terminal device.

Optionally, the storing file may be stored in a file device provided in the terminal device.

Optionally, the management information and the storing file are stored in the terminal device on a directory-by-directory basis.

According to another aspect of the invention, there is provided a computer program to be executed by a computer to achieve a method of browsing contents on a network in an offline mode of a terminal device. The method includes the steps of: receiving a request for an object designated by a URI (Uniform Resource Identifier); reading out the requested object from a storing file, which stores a Web page containing at least one object, by using management information which is used to search for the requested object in the storing file using the URI as a keyword; and displaying the requested object read out from the storing file.

With this configuration, a transition from a Web page to another Web page selected by, for example, an anchor selection can be attained in the offline mode. That is, the offline browsing is performed as if the terminal device is in the online mode.

Optionally, the storing file may contain a plurality of objects. In this case, the management information may include for each of the plurality of objects:

(a) the URI of a target object;

(b) a file name of the storing file including the target object; and

(c) address information of the target object in the storing file. Further, in this case, the reading out the requested object from the storing file may include searching the management information to obtain the file name of the storing file containing the requested object and to obtain the address information of the requested object, and reading out the requested object from the searched storing file using the obtained file name and the address information.

Still optionally, the management information may include for each of the plurality of objects:

(d) one of a latest update time of the target object and an acquisition time of the target object. In this case, the reading out the requested object from the storing file may include: selecting latest one from objects having the same URI corresponding to the requested object using the management information if two or more objects having the same URI corresponding to the requested object are stored in one or more storing files; and reading out the latest one from the storing file using the file name and the address information concerning the latest one.

Alternatively, the management information may include for each of the plurality of objects: (d) one of a latest update time of the target object and an acquisition time of the target object. In this case, the reading out the requested object from the storing file may include: if two or more objects having the same URI corresponding to the requested object are stored in one or more storing files, displaying the file name and/or the acquisition time regarding the two or more objects so that a user can selects one of the two or more object; and reading out one of the two or more objects selected by the user from the storing file using the file name and the address information concerning the object selected by the user.

Alternatively, the management information may include for each of the plurality of objects: (d) one of a latest update time of the target object and an acquisition time of the target object. In this case, the reading out the requested object from the storing file may include: if two or more objects having the same URI corresponding to the requested object are stored in one or more storing files, selecting one of the two or more objects, wherein the one of the two or more objects has the acquisition time nearest to the acquisition time of an Web page previously displayed before the requested object currently requested is designated by a user on the previously displayed Web page; and reading out the selected object from the storing file using the file name and the address information concerning the selected object.

In a particular case, the management information may further include for each of the plurality of objects: (e) verification data which is used to verify that the storing file including the target object is not changed from a time when the storing file containing the target object is initially registered. In this case, the reading out the requested object from the storing file may include reading out the requested object only when it is confirmed that the verification data corresponding to the requested object is consistent with the storing file containing the requested object.

Optionally, the verification data may include at least one of a file size, a time stamp, a checksum and a CRC concerning the storing file.

Optionally, the verification data may includes a message digest including one of an MD5 and SHA-1.

In a particular case, the URI of the requested object may be inputted by a user by a letter input through use of a user interface device.

In a particular case, the URI of the requested object may be designated by a user by an anchor selection.

In a particular case, the storing file may contain a single object, and the management information may include for each of the plurality of objects:

(a) the URI of a target object; and

(b) a file name of the storing file including the target object.

Optionally, the method may include creating or updating the management information when the Web page is stored as the storing file.

Optionally, the method may include creating or updating the management information based on the storing file being stored when the terminal device changes from an online mode to the offline mode.

Optionally, the method may include creating or updating the management information when it is found that the storing file having the searched file name is not exist in actuality.

Optionally, the method may include: detecting file operation regarding the storing file; and creating or updating the management information in accordance with a type of the file operation. The file operation may include at least one of addition, update and deletion of the storing file.

In a particular case, the method may include when it is detected that the verification data corresponding to the requested object is not consistent with the storing file containing the requested object, updating the management information for the storing file which is not consistent with the verification data.

Optionally, the management information may be stored on a memory in the terminal device.

Optionally, the management information may be stored as a file in a file device provided in the terminal device.

Optionally, the storing file may be stored in a file device provided in the terminal device.

Optionally, the management information and the storing file are stored in the terminal device on a directory-by-directory basis.

According to another aspect of the invention, there is provided a computer program product providing a set of instructions executed by a terminal device, the terminal device executing the instructions functioning as browsing contents on a network in an offline mode. The computer program product comprising functions of: receiving a request for an object designated by a URI (Uniform Resource Identifier); reading out the requested object from a storing file, which stores a Web page containing at least one object, by using management information which is used to search for the requested object in the storing file using the URI as a keyword; and displaying the requested object read out from the storing file.

With this configuration, a transition from a Web page to another Web page selected by, for example, an anchor selection can be attained in the offline mode. That is, the offline browsing is performed as if the terminal device is in the online mode.

According to another aspect of the invention, there is provided a terminal device, which includes an obtaining system that obtains a Web page through a network and stores at lest one objects contained in the Web page into a storing file, and a management information creating system that creates management information which is used to search for an object in the storing file using a URI of the object as a keyword. The terminal device further includes a searching system that searches the management information to find a requested object designated by the URI and reads out the requested object from the storing file, and a displaying system that displays the requested object read out from the storing file.

With this configuration, a transition from a Web page to another Web page selected by, for example, an anchor selection can be attained in the offline mode. That is, the offline browsing is performed as if the terminal device is in the online mode.

According to another aspect of the invention, there is provided a terminal device, which includes an automatic accessing system that automatically accesses Web pages, which are designated in advance in an URI list, and stores the accessed Web pages into storing files, and a management information creating system that creates management information which is used to search for an object in the storing files using a URI of the object as a keyword. The terminal device further includes a searching system that searches the management information to find a requested object designated by the URI and reads out the requested object from one of the storing files, and a displaying system that displays the requested object read out from the one of the storing files.

With this configuration, a transition from a Web page to another Web page selected by, for example, an anchor selection can be attained in the offline mode. That is, the offline browsing is performed as if the terminal device is in the online mode. The Web pages are automatically collected by the automatic accessing system.

Optionally, the automatic accessing system may be configured to access linked pages contained in the accessed Web page and to save the linked pages through the network as well as the Web pages listed in the URI list.

Still optionally, the automatic accessing system may be configured to consult firstly the management information to determine whether the Web pages in the URI list is already exist in the terminal device. Further, the automatic accessing system may obtain each Web page through the network only when it is determined that the each Web page in the URI list does not exist in the terminal device.

### BRIEF DESCRIPTION OF THE DRAWINGS

The present invention will be understood and appreciated from the following detailed description, taken in conjunction with the drawings in which:

FIG. 1 shows a block diagram of a terminal device according to an embodiment of the invention;

FIG. 2 is a functional block diagram of a browser engine when the terminal device is in an online mode;

FIG. 3 shows a functional block diagram of the browser in the offline mode;

FIG. 4 is an example of a map of a page memo file containing a Web page including two image files;

FIG. 5 shows a configuration of page memo management information;

FIG. 6 shows a flow of operation of a database searching unit in the browser; and

FIG. 7 shows an example of a filing configuration in which the page memo management information and related page memo files is stored in the terminal device on a directory-by-directory basis.

### DETAILED DESCRIPTION OF THE EMBODIMENT

Hereinafter, embodiments of the invention will be described with reference to the accompanying drawings.

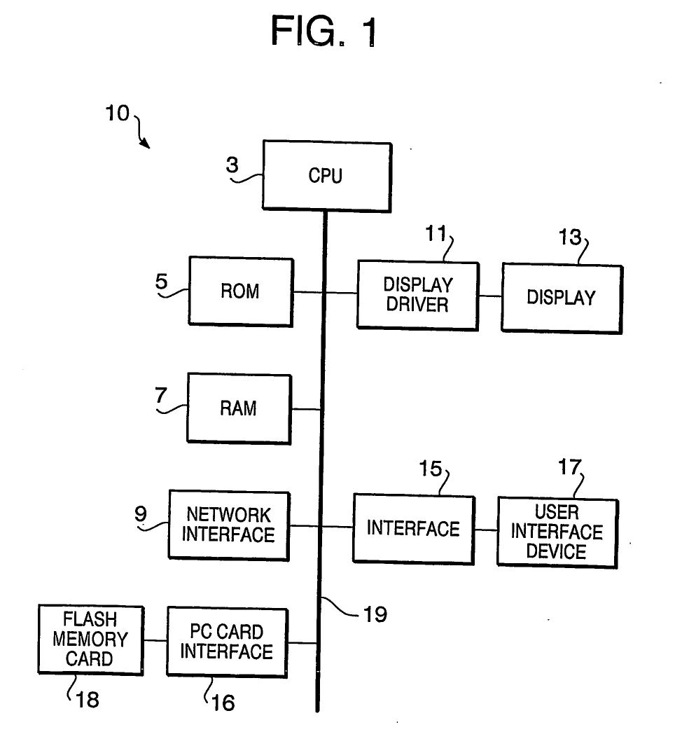

FIG. 1 shows a block diagram of a terminal device 10 according to an embodiment of the invention. As shown in FIG. 1, the terminal device 10 includes a CPU 3 (Central Processing Unit) which controls various functions that the terminal device 10 has. A browser 50 runs on the terminal device 10 under the control of the CPU 3. The terminal device 10 may be one of various types of terminal devices including a personal computer, a PDA, a mobile phone, a car navigation system and a household electrical appliance connected to a network.

As shown in FIG. 1, the terminal device 10 further includes a ROM (Read-Only Memory) 5, a RAM (Random-Access Memory) 7, a network interface 9, a PC card interface 16, a display driver 11 and an interface 15, which are connected to the CPU 3 via a bus 19. Further, the terminal device 10 has a display 13 connected to the display driver 11, and a user interface device 17 such as a keyboard connected to the interface 15.

Various types of PC cards can be attached to the terminal device 10 via the PC card interface 16. In this embodiment, a flash memory card 18 is attached to the terminal device 10 via the PC card interface 16.

In the ROM 5, various types of computer programs including a program of the browser 50 are stored. When a user performs predetermined operation using the user interface device 17, the browser 50 is initiated.

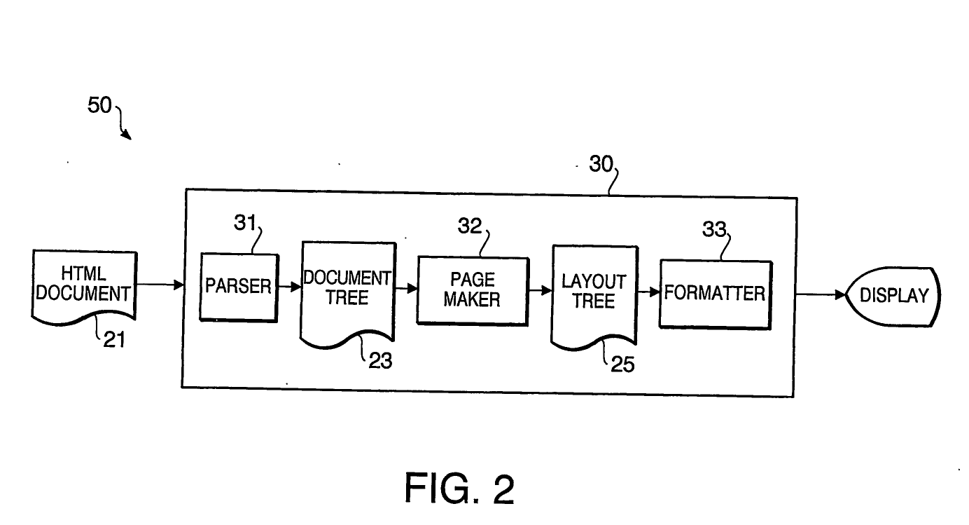

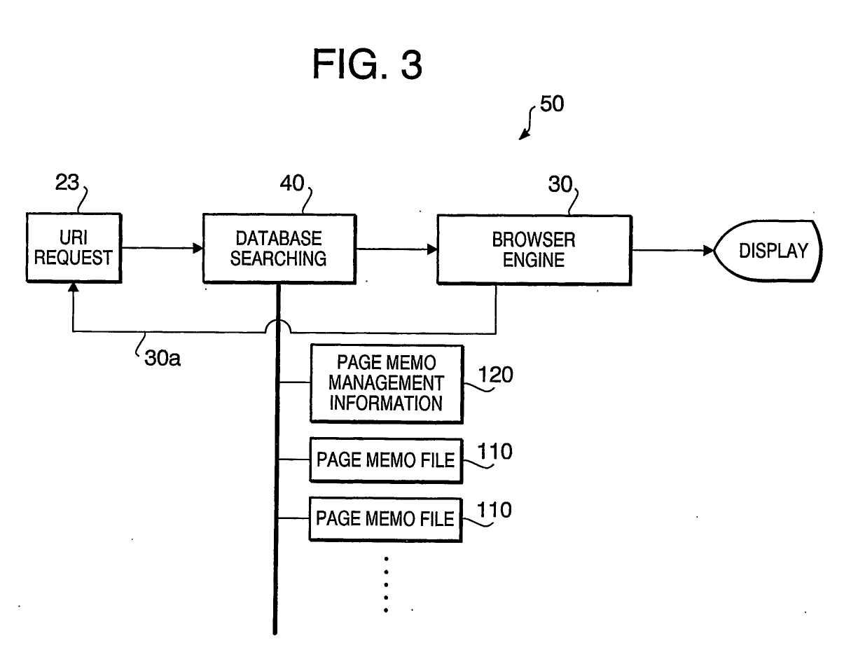

Hereafter, functions of the browser 50 will be described with reference to FIGS. 2 and 3. Firstly, the function of a browser engine 30 which is a main component of the browser 50 is explained with reference to FIG. 2. Secondly, operation of the browser 50 in an offline mode will be explained with reference to FIG. 3.

FIG. 2 is a functional block diagram of the browser engine 30 when the browser 50 is in an online mode (i.e., when the terminal device 10 is connected to a network). As shown in FIG. 2, the browser 50 has functional blocks of a parser 31, a page maker 32 and a formatter 33.

When the user inputs a URI using the user interface device 17 or the user designates a URI by selecting one of anchor tags in a Web page being displayed on the display 13, the browse 50 operates to obtain an HTML document 21 (i.e., a requested object) from the URI on the Internet. The obtained HTML document 21 is then inputted to the parser 31.

The parser 31 parses the HTML document 21 that is obtained from the Internet via the network interface 9 so as to make a document tree 23 in which a grammatical structure of the HTML document 21 is expressed by a tree structure. It should be noted that the document tree 23 only expresses the grammatical structure of the HTML document 21, and does not include information concerning presentation of the HTML document 23.

Next, based on the document tree 23 and information concerning tags, the page maker 32 makes a layout tree 25 in which forms of presentation of the HTML document 21, for example, block, inline, table, list, item and the like are included. That is, the layout tree 25 includes information about the order of data such as block, inline, table and the like in the HTML document 21. It should be noted that the layout tree 25 does not include information about positions and sizes of such items (block, inline, table, etc.) on the screen of the display 13.

Based on the layout tree 25 and information concerning the screen size of the display 13, the formatter 33 lays out the items on the screen of the display 13. That is, the formatter 33 arranges the items in the layout tree 25 on the screen of the display 13, and determines positions, widths and heights of the items and positions of carriage returns for letters in the HTML document 21.

Through such processes performed by the parser 31, the page maker 32 and the formatter 33, the HTML document 21 is properly displayed on the screen of the display 13.

The browser 50 further has the function of storing the Web page being displayed on the display 13 in a predetermined file format. By performing certain operation using the user interface device 17, the user can save the Web page being displayed on the display into, for example, the flush memory card 18 as a file having the predetermined file format. Hereafter, such a file containing Web pages (i.e., objects), which is created by the browser 50 and which has the predetermined format, is referred to as a page memo file 110 or a page storing file. It is understood from the following explanations that the predetermined file format of the page memo file is different from that of a cached file.

By accessing desirable Web pages and save the Web pages using the browser 50, the user can browse the Web pages in the offline mode later without concern for connection fees.

The browser 50 further has the function of creating a database for managing all page memo files 110 stored in the terminal device 10. Hereafter, the database for managing all page memo files 110 created by the browser 50 is referred to as page memo management information 120 (see FIG. 3). The page memo management information 120 may be created as a file in the flush memory card 18.

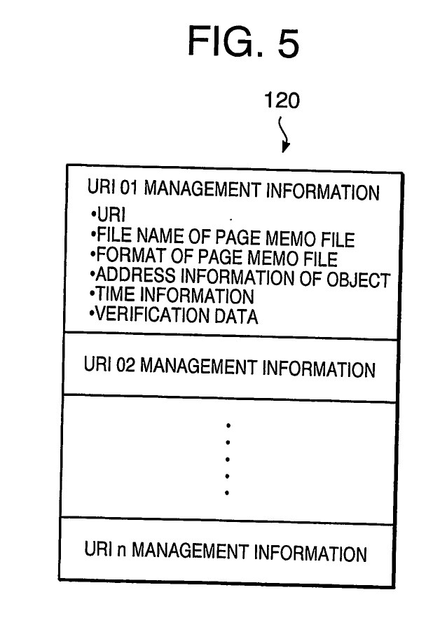

As described in detail later with reference to FIG. 5, the page memo management information 120 includes information on whether or not an object, such as an image file and an HTML document, designated by a URI is stored in the terminal device 10 as a page memo file 110, and information concerning a position of a target object in the page memo file 110. That is, in the page memo management information 120, information concerning objects is stored by a URI-by-URI basis.

FIG. 3 shows a functional block diagram of the browser 50 in the offline mode. As shown in FIG. 3, in the offline mode, when the user designates an URI, that the user wants to browse, by using the user interface device 17, an URI request 23 is generated and is inputted to a database searching unit 40.

The database searching unit 40 searches the page memo management information 120 for an object corresponding to the requested URI (i.e., the URI request 23).

Typical factors contributing to generate the URI request 23 are letter input (through the user interface device 17) and an anchor selection by the user. Another factors contributing to generate the URI request 23 are as follows.

selection of a destination URI by use of a-bookmark.

selection of a “Back” or “Forward” button indicated on a browsing window (not shown) displayed by the browser 50 on the display 13.

reloading of a Web page by a user selection of a “Refresh” button indicated on the browsing window.

obtaining of an image file designated in an <img> tag in the obtained Web page.

obtaining of external style sheets through a network.

obtaining of a frame page designated in a <frame> tag or a <iframe> tag in the obtained Web page.

refresh operation caused by a <meta http-equiv=“refresh”> tag, etc.

a transition to another Web page caused, for example, by a JavaScript.

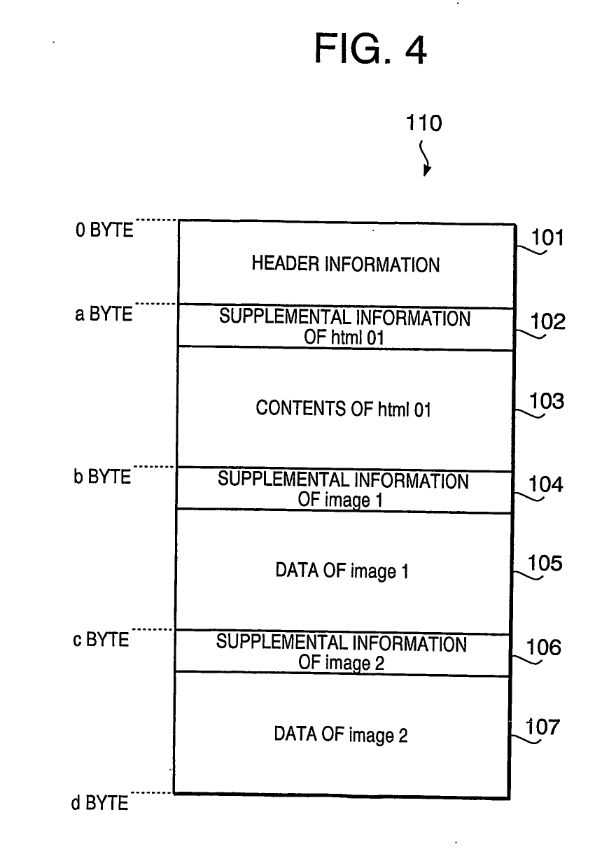

FIG. 4 is an example of a map of the page memo file 110 which contains a Web page including two image files. In the following explanation, the Web page shown in FIG. 4 is represented by “htm101”, and two image files in the Web page of FIG. 4 are represented by “image 1” and “image 2”, respectively.

As shown in FIG. 4, the page memo file 110 includes header information 101 at the top (0 byte˜a byte) of the page memo file 110. The header information 101 includes general information concerning the page memo file 110, for example, a fact that the page memo file 110 is encoded by a MIME format. The following is an example of the header information 101.

[Example of Header Information 101]

From:

Subject: ACCESS

Date: Mon, 12 May 2003 13:46:48 +0900

MIME-Version: 1.0

Content-Type: multipart/related;
boundary=“ - - - =_NextPart_{—}000_{—}000_{—}01C3188C.EF7C3A90”;
type=“text/html”

This is a multi-part message in MIME format.

Next to the header information 101, supplemental information 102 of the html 01 and contents 103 of the html 01 are included. In the supplemental information 102 of the html 01, a URI of the html 01, an encoding format of the html 01 and etc. are included. The following is an example of the supplemental information 102 of the html 01.

[Example of Supplemental Information 102]

- - - =_NextPart_{—}000_{—}0000_{—}01C3188C.EF7C3A90

Content-Type: text/html;
charset=“shift_jis”

Content-Transfer-Encoding: quoted-printable

Content-Location: http://www.access.co.jp/top.html

Next to the contents 103 of the html 01, supplemental information 104 of the image 1 and data 103 of the image 1 are included. In the supplemental information 104 of the image 1, a format of the image 1, a URI of the image 1, an encoding format of the image 1 and etc. are included. The following is an example of the supplemental information 104 of the image 1.

[Example of Supplemental Information 104]

- - - =_NextPart_{—}000_{—}0000_{—}01C3188C.EF7C3A90

Content-Type: image/gif

Content-Transfer-Encoding: base64

Content-Location:

http://www.access.co.jp/newimages/logo.gif

Next to the data 105 of the image 1, supplemental information 106 of the image 2 and data 104 of the image 2 are included. Similarly to the supplemental information 102, in the supplemental information 104 of the image 2, a format of the image 2, a URI of the image 2, an encoding format of the image 2 and etc. are included.

FIG. 5 shows a configuration of the page memo management information 120. The page memo management information 120 includes information which enables to find a requested object from page memo files 110. The information of the requested object can be found out in the page memo management information 120 by using a URI of the requested object as a keyword.

More specifically, the page memo management information 120 includes following information for each of URIs.

a target URI (a target object)

a file name of a page memo file 110 in which the target URI is stored.

a format of the page memo file 110.

address information (a start address and an end address) of the target URI (the target object) in the page memo file 110.

time information on the target URI ( the target object) (e.g., a latest update time of the target object or an acquisition time at which the target object is obtained by the terminal device 10)

verification data

The verification data is used to verify that the page memo file 110 including the target URI is not changed. For example, the verification data is one of a file size, a time stamp, a portion of data of the target object, a checksum and a CRC (cyclic redundancy check) code of the page memo file 110 when the page memo file 110 is first registered. The verification data may be a message digest such as a MD5 (Message Digest 5) and SHA-1 (Secure Hash Algorithm 1).

The time information is used to select a latest object when a plurality of objects having the same URI is included in one or more page memo files 110 stored in the terminal device 10, and to display the latest object on the display 13.

The time information may be used as follows.

(a) If two or more objects having the same URI corresponding to the requested object are stored in one or more page memo files, the browser 50 displays the file name and/or the acquisition time regarding the two or more objects on the display 13, for example, by a dialog message, so that a user can selects one of the two or more object. Then, the user selected object is obtained from the page memo file 110 and is displayed.

(b) If two or more objects having the same URI corresponding to the requested object are stored in one or more page memo files, the browser 50 selects one of the two or more objects. The one of the two or more objects has the acquisition time nearest to the acquisition time of an Web page previously displayed before the requested object currently requested is designated by a user (for example, by an anchor selection) on the previously displayed Web page. Then, the selected object is obtained from the page memo file 110 and is displayed.

The following is an example of the page memo management information 120 regarding the page memo file 110 shown in FIG. 4. In the following, a file name of the page memo file 110 is represented by “access_about_acces_.htm”.

[Example of Page Memo Management Information 120]

URI http://www.access.co.jp/top.html
FILE NAME: access_about_acces_.mht
FORMAT: mht
START ADDRESS: a byte
END ADDRESS: b byte
TIME: 2003/04/22 12:00:00.00

URI http://www.access.co.jp/newimages/logo.gif
FILE NAME: access_about_acces_.mht
FORMAT: mht
START ADDRESS: b byte
END ADDRESS: c byte
TIME: 2003/04/22 12:00:00.00

URI http://www.access.co.jp/newimages/logo2.gif
FILE NAME: access_about_acces_.mht
FORMAT: mht
START ADDRESS: c byte
END ADDRESS: d byte
TIME: 2003/04/22 12:00:00.00

Referring now to FIG. 3 again, the database searching unit 40 searches the page memo management information 120 for the requested URI which has been inputted thereto as the URI request 23. If the requested URI is found in the page memo management information 120, the requested object is read out from the page memo file 110 including the requested object by using the address information of the requested object contained in the page memo management information 120.

The requested object read out from the page memo file 110 is then inputted to the browser engine 30. If an HTML document inputted to the browser engine 30 includes links (e.g., hyperlinks to image files), a new URI request 23 may be created (see an arrow 30a in FIG. 3).

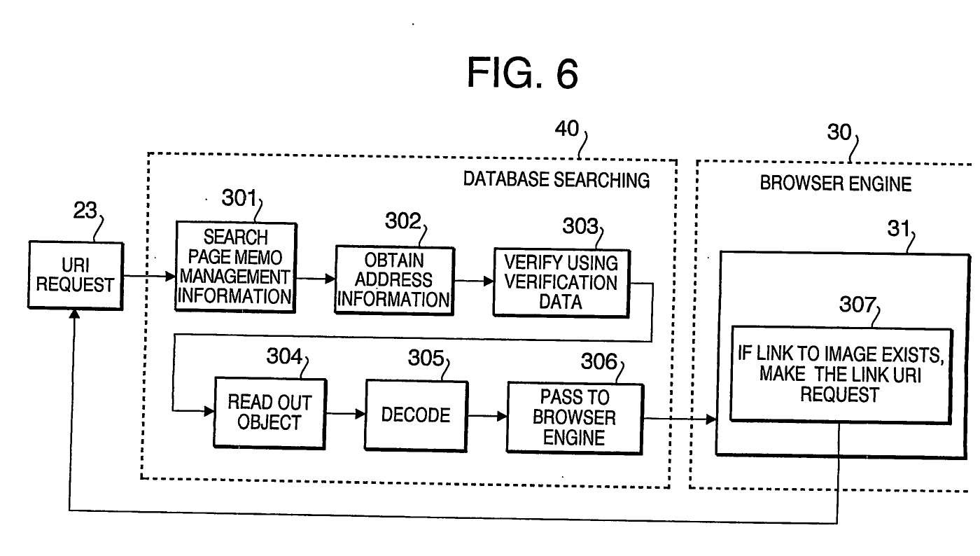

FIG. 6 shows a flow of operation of the database searching unit 40. As shown in FIG. 6, after the URI request 23 is inputted to the database searching unit 40, the database searching unit 40 searched the page memo management information 120 for the requested object (301). When the requested URI is found in the page memo management information 120, address information of the requested URI is obtained from the page memo management information 120 (302).

Next, by using the verification data of the requested URI stored in the page memo management information 120, the database searching unit 40 checks whether the page memo file containing the requested URI is modified or not (303).

Given that the verification data is a file size of the page memo file 110 containing the requested object, the file size stored in the page memo management information 120 as the verification data is compared with a current file size of the page memo file containing the requested object. Only when the two file sizes are equal to each other, the requested object is read out from the page memo file 110.

By thus verifying that the page memo file 110 is not changed using the verification data, it is prevented that improper data is read out from the page memo file 110 as data of the requested object. Such an improper reading out of the object may occur, for example, when the page memo file 110 containing the requested object is modified and does not contain the requested object even though the page memo management information 120 includes the requested URI.

If the verification data (the file size) coincides with the current file size of the page memo file 110 containing the requested object, the requested object is read out from the page memo file 110 (304). Next, data of the read out object is decoded in accordance with the encoding format of the requested object contained in the supplemental information (305). The decoded object is then inputted to the browser engine 30 to display the object.

If it is determined in the parser 31 of the browser engine 30 that the decoded object is an HTML document and the HTML document includes links to image files, a new URI request for the image files are created (307, 23). Then, the database searching unit 40 searches the page memo management information 120 for the new URI request (301).

With the above mentioned process performed by the database searching unit 40, the Web page, which the user wants to read in the offline mode, is searched and read out from the mage memo file 110, and then is displayed on the display 13.

In the page memo management information 120, information for finding a requested object from all the page memo files 110 stored in the terminal device 10 is included. In other words, the page memo management information 120 includes information, concerning the page memo files, on an object-by-object basis. Therefore, it becomes possible to cause a transition on the display 13 from a Web page to another Web page in the offline mode. That is, when the user selects one of anchor tags in a Web page displayed on the display 13, a selected object is read out from the page memo files 110 and is displayed on the display 13 by the browser 50.

As described above, according to the embodiment of the invention, the transition from a Web page to another Web page selected by, for example, an anchor selection can be attained in the off line mode. That is, the offline browsing is performed as if the terminal device 10 is in the online mode.

Further, according to the above mentioned configuration of the browser 50, the following advantages are accomplished.

(1) A partial data in the page memo file 110 (i.e., an object included in the page memo file) can be targeted for the displaying process of the browser engine 30. That is, since the address information of a requested object can be known from the page memo management information 120, it is not required to read out the whole data of the page memo file 110 containing the requested object. Therefore, a processing time and a memory size for obtaining the requested object can be reduced.

(2) A page memo file 110 is not automatically deleted after the expiration of a certain time period as in the case of cached files which are cached by using the function of the browser.

(3) In general, when cache files are saved by the function of the browser, the cache files are associated with URIs in a one-to-one relationship. That is, for one URI, only one cache file is stored. By contrast, according to the embodiment of the invention, a plurality of objects having the same URI may be stored in one or more page memo files 110. Therefore, even if a page memo file 110 containing an image file A which is frequently used is deleted, the image file A can be read out in the offline mode as long as the image file A is stored in another page memo file 110.

The followings are examples of timing at which the page memo management information 120 is created or updated.

(A-1) The browser 50 creates the page memo management information 120 when a Web page is obtained and is stored in the terminal device 10 as a page memo file 110 (i.e., when the page memo file 110 is created).

(A-2) When a file name of a requested object is found in the page memo management information 120, but when a page memo file corresponding to the file name does not exist in the terminal device 10, all of fields, in the page memo management information 120, related to the requested object are deleted, assuming that the page memo file 110 is deleted without management of the browser 50.

(A-3) When a mismatch between a verification data and its corresponding page memo file 110 is detected, all of fields, in the page memo management information 120, related to the page memo file 110 are updated after the page memo file 110 is analyzed, assuming that the page memo file 110 is modified without management of the browser 50.

(A-4) When one of operations including addition of a page memo file 110, update of a page memo file 110 and deletion of a page memo file 110 is detected, the page memo management information 120 is created or updated in accordance with the type of the operation. More specifically, the page memo management information 120 is created or updated in the following cases.

(A-4-1) When a page memo file which is to be managed by the browser 50 is newly added to the terminal device 10, for example, by importing the page memo file from an external terminal device or an external file device, such as a flash memory card, into the terminal device 10.

(A-4-2) When a page memo file 110 under control of the browser 50 is deleted, all fields related to a file name of the deleted page memo file 110 in the page memo management information 120 are deleted.

(A-4-3) When a page memo file 110 under control of the browser 50 is moved or updated, all fields related to the moved or updated page memo file 110 in the page memo management information 120 are updated.

The above mentioned moving, updating, and deleting operation of a file can be detected by various methods including the followings. One of methods for detecting movement, update and deletion of a file is to prepare a file operation menu as the function of the browser 50 so that a user performs file operation through the use of the file operation menu of the browser 50. In this case, the file operation can be detected by the browser 50.

Another method for detecting movement, update and deletion of a file is to detect the file operation by using a notification from an operating system. Another method for detecting movement, update and deletion of a file is to detect the file operation by scanning page memo files under control of the browser 50 (for example, stored in a certain directory) at regular intervals.

(A-5) When the terminal device 50 is changes from the online mode to the off line mode, page memo files are analyzed and the page memo management information 120 is created or updated.

(A-6) When the browser engine 30 starts to search the page memo management information 120, only if the page memo management information 120 is not created, the browser 50 creates the page memo management information 120.

Although the present invention has been described in considerable detail with reference to certain preferred embodiments thereof, other embodiments are possible.

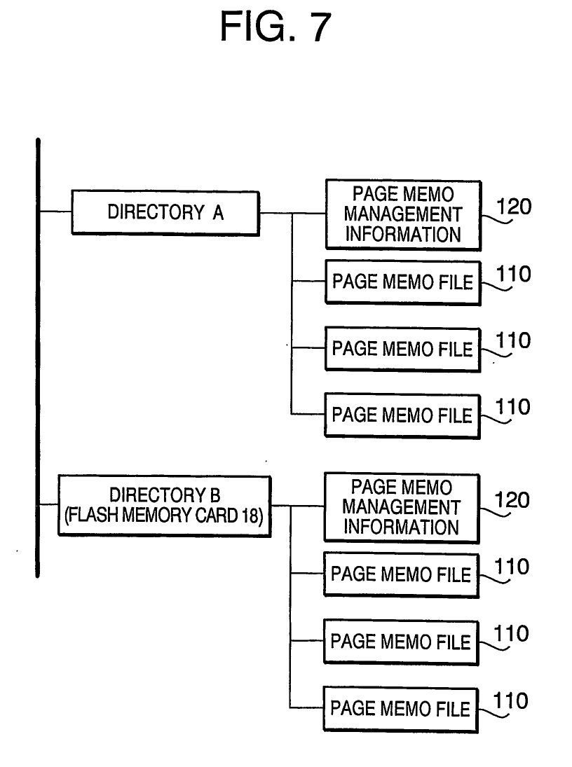

Although in the above mentioned embodiment it is explained that the page memo management information and the page memo files are stored in the flash memory card 18, other embodiments are possible. For example, as shown in FIG. 7, the page memo management information 120 and related page memo files 110 may be stored in the terminal device 10 on a directory-by-directory basis. In FIG. 7, two directories A and B are created by the user for separately managing two groups of page memo files. In FIG. 7, the page memo management information 120 and its related page memo files 110 are stored for each of the directories A and B. It is noted that the directory B is created in the flash memory card 18, and the directory A is created in another storage device in the terminal device 10. In this case, the user can attach the flash memory card 18 containing favorite page memo management information 120 and page memo files 110 to another terminal device and can enjoy browsing the favorite Web pages on another terminal device in the offline mode.

The page memo management information 120 may further include the followings.

a request method used in HTTP (hypertext transfer protocol) (i.e., a GET method or a POST method)

contents of POST data when the request method is the POST method.

a received HTTP header.

By further using the above listed additional information for the page memo management information 120, management of objects (i.e., page memo files) can be performed in more detail.

Although in the above mentioned embodiment one page memo file 110 is prepared for one Web page (i.e., the page memo files are associated with Web pages in a one-to-one relationship), another embodiment in which a page memo file is prepared for one object is possible. In this case, with regard to the example of the page memo file 110 shown in FIG. 4, the html 01, the image 1 and the image 2 are stored in different page memo files (i.e., three page memo files are created for the html 01, the image 1 and the image 2, respectively.). It is understood in this case that the address information (i.e., the start address and end address of the object) is not required. Therefore, in this case, necessary data items of the page memo management information 120 for each of objects (URIs) are:

URI, and

a file name of a page memo file.

Although in the above mentioned embodiment, the page memo management information 120 is stored in file devices such as a flash memory card 18, the page memo management information 120 may be stored in the RAM 7. That is, the page memo management information 120 may be used on a memory (i.e., in an “on-memory” basis). In this case, the browser 50 may move the page memo management information 120 saved on the memory (RAM 7) into the file device as a file at the termination of the browser 50, and may copy the page memo management information 120 stored in the file device to the memory (RAM 7) at the initiation of the browser 50. Alternatively or additionally, the browser 50 may update the page memo management information 120 stored in the file device as a file when the page memo management information 120 saved in the memory is updated.

Alternatively or additionally, the browser 50 may add the page memo management information 120 stored in a directory in the flash memory card 18 to the memory (RAM 17) when the flash memory card 18 is attached to the terminal device 10 via the PC card interface 16. In addition, when the page memo management information 120 is added to the memory (RAM 7), a verification between the information added to the memory and the page memo files stored in the directory of the flash memory 18 may be performed to confirm the correctness of the added information. Further, the correction of the added information may be performed by analyzing the page memo files stored in the directory of the flash memory card 18 if a mismatch is detected between the added information and the page memo files stored in the directory of the flash memory card 18.

Although in the above mentioned embodiment, the page memo file 110 is used only for off line browsing, the page memo file 110 may be used in place of cached files in the online mode or may be used as cached files in addition to cached files saved by the caching function of the browser 50. That is, the browser 50 may use page memo files 110 to display a requested URI in the online mode.

The following is an example of procedure for using page memo files 110 along with cached files in the online mode:

(step 1) searching a memory cache or a disc cache for a requested URI when a URI request occurs,

(step 2) searching the page memo management information 120 for the requested URI if the requested URI is not found in the memory cache and the disc cache,

(step 3) reading out the requested object from the page memo file and displaying it if it is found in one of page memo files.

The above mentioned procedure corresponds to one of settings of the casing function of the browser 50, i.e., to use the memory cache as a level 1 cache, to use the disc cache as a level 2 cache and to use the page memo file as a level 3 cache.

In the above mentioned embodiment, the page memo file 110 is stored manually by the user when the user accesses a desired Web page using the browser 50. However, the page memo files may be saved automatically by automatic accessing software which automatically accesses web pages, which are designated in advance in an URI list, and stores the accessed Web pages into page memo files.

The automatic accessing software may operate as follows. The automatic accessing software may consult firstly the page memo management information 120 and may determine whether accessing to the Web page on a network is necessary or not to store requested Web pages listed in the URI list.

The automatic accessing software may be configured to further access linked pages contained in the accessed Web page and to save the linked pages as well as the Web pages listed in the URI list.

For example, by using the time information included in the page memo management information 120, the requested object may be obtained from a server on the network only when a created time of the object on the server is newer than the time information of the requested object stored in the page memo management information 120. Such verification of renewal between the terminal device 10 and the server on the network can be performed by using a certain type of HTTP header.

The automatic accessing software may have additional functions as follows. That is, the automatic accessing software may be configured to operate in accordance with predetermined rules:

(1) preparing a check flag in the page memo management information 120 for each of objects (URIs), the check flag being used to indicate whether an update of the object (URI) is confirmed or not,

(2) setting all of the check flags in the page memo management information 120 to unconfirmed states at the time of termination of a sequence of operation for accessing the Web pages listed in the URI list (i.e., one-time routine accessing to Web pages listed in the URI list) or at the time of initiation of the sequence of operation for accessing the Web pages listed in the URI list.

(3) when an unregistered object (i.e., an object which is not registered in the page memo management information 120) is obtained from a server and the obtained object is newly registered in the page memo management information 120, setting the check flag of the newly registered object to a confirmed state,

(4) if a query for confirming a renewal of an object is sent to the server, setting the check flag of an object having the unconfirmed state to the confirmed state regardless of the result of the query to the sever, and

(5) not sending the query for confirming a renewal of an object to a server with regard to the object (URI) having the confirmed state.

By operation in accordance with the above mentioned rules, the automatic accessing software communicates with a server only when a request for a certain URI occurs at the first time during the execution of the automatic accessing software. That is, duplication of access for one URI is eliminated. Accordingly, if the automatic accessing software is configured to automatically obtain linked URIs (linked objects) and a certain Web page is directly or indirectly linked from the plurality of Web pages listed in the URI list, the amount of data for communicating with servers and a time required for execution of the automatic accessing software can be reduced. Further, the load on the network and the server can be reduced. An “indirectly linked page” means that a certain Web page is linked from the plurality of Web pages listed in the URI list via one or more intervening Web pages.

The above mentioned automatic accessing software may be implemented as one of the functions of the browser 50.

Although in the above mentioned embodiment, the page memo files and the page memo management information are stored in local storage devices (e.g., the RAM 7 and the flash memory card 18), other embodiments are possible. For example, the page memo files and the page memo management information may be stored in a file server connected to a LAN (local area network). In this case, the above mentioned offline browsing can be performed on client terminal devices connected to the LAN.

The above mentioned offline browsing can be performed with regard to contents placed on various types of networks such as a public switched telephone network and a mobile phone network as well as the Internet.

The device and method according to the present invention can be realized when appropriate programs are provided and executed by a computer. Such programs may be stored in recording medium such as a flexible disk, CD-ROM, memory cards and the like and distributed. Alternatively or optionally, such programs can be distributed through networks such as the Internet.

1. A method of browsing contents on a network in an off line mode of a terminal device, comprising:
receiving a request for an object;
reading out the requested object from a storing file, which stores at least one object obtained from the network and has a predetermined file format, by using management information including relationship between location information locating the requested object on the network and a file name of the storing file containing the requested object; and
displaying the requested object read out from the storing file.

2. The method according to claim 1,
wherein the storing file contains a plurality of objects,
wherein the management information includes for each of the plurality of objects:
(a) the location information of a target object;
(b) the file name of the storing file including the target object; and
(c) address information of the target object in the storing file.

3. The method according to claim 2,
wherein said reading out the requested object from the storing file includes:
searching the management information to obtain the file name of the storing file containing the requested object and to obtain the address information of the requested object; and
reading out the requested object from the searched storing file using the obtained file name and the address information.

4. A method of browsing contents on a network in an offline mode of a terminal device, comprising:
receiving a request for an object designated by a URI (Uniform Resource Identifier);
reading out the requested object from a storing file, which stores a Web page containing at least one object, by using management information which is used to search for the requested object in the storing file using the URI as a keyword; and
displaying the requested object read out from the storing file.

5. The method according to claim 4,
wherein the storing file contains a plurality of objects,
wherein the management information includes for each of the plurality of objects:
(a) the URI of a target object;
(b) a file name of the storing file including the target object; and
(c) address information of the target object in the storing file,
wherein said reading out the requested object from the storing file includes:
searching the management information to obtain the file name of the storing file containing the requested object and to obtain the address information of the requested object; and
reading out the requested object from the searched storing file using the obtained file name and the address information.

6. The method according to claim 5,
wherein the management information further includes for each of the plurality of objects:
(d) one of a latest update time of the target object and an acquisition time of the target object,
wherein said reading out the requested object from the storing file includes:
selecting latest one from objects having the same URI corresponding to the requested object using the management information if two or more objects having the same URI corresponding to the requested object are stored in one or more storing files; and
reading out the latest one from the storing file using the file name and the address information concerning the latest one.

7. The method according to claim 5,
wherein the management information further includes for each of the plurality of objects:
(d) one of a latest update time of the target object and an acquisition time of the target object,
wherein said reading out the requested object from the storing file includes:
if two or more objects having the same URI corresponding to the requested object are stored in one or more storing files, displaying the file name and/or the acquisition time regarding the two or more objects so that a user can selects one of the two or more object; and
reading out one of the two or more objects selected by the user from the storing file using the file name and the address information concerning the object selected by the user.

8. The method according to claim 5,
wherein the management information further includes for each of the plurality of objects:
(d) one of a latest update time of the target object and an acquisition time of the target object,
wherein said reading out the requested object from the storing file includes:
if two or more objects having the same URI corresponding to the requested object are stored in one or more storing files, selecting one of the two or more objects, wherein the one of the two or more objects has the acquisition time nearest to the acquisition time of an Web page previously displayed before the requested object currently requested is designated by a user on the previously displayed Web page; and
reading out the selected object from the storing file using the file name and the address information concerning the selected object.

9. The method according to claim 5,
wherein the management information further includes for each of the plurality of objects:
(e) verification data which is used to verify that the storing file including the target object is not changed from a time when the storing file containing the target object is initially registered,
wherein said reading out the requested object from the storing file includes:
reading out the requested object only when it is confirmed that the verification data corresponding to the requested object is consistent with the storing file containing the requested object.

10. The method according to claim 9,
wherein the verification data includes at least one of a file size, a time stamp, a checksum and a CRC concerning the storing file.

11. The method according to claim 9,
wherein the verification data includes a message digest including one of an MD5 and SHA-1.

12. The method according to claim 4,
wherein the URI of the requested object is inputted by a user by a letter input through use of a user interface device.

13. The method according to claim 4,
wherein the URI of the requested object is designated by a user by an anchor selection.

14. The method according to claim 4,
wherein the storing file contains a single object,
wherein the management information includes for each of the plurality of objects:
(a) the URI of a target object; and
(b) a file name of the storing file including the target object.

15. The method according to claim 4, further comprising:
creating or updating the management information when the Web page is stored as the storing file.

16. The method according to claim 4, further comprising:
creating or updating the management information based on the storing file being stored when the terminal device changes from an online mode to the offline mode.

17. The method according to claim 5, further comprising:
creating or updating the management information when it is found that the storing file having the searched file name is not exist in actuality.

18. The method according to claim 4, further comprising:
detecting file operation regarding the storing file; and
creating or updating the management information in accordance with a type of the file operation,
wherein the file operation includes at least one of addition, update and deletion of the storing file.

19. The method according to claim 9, further comprising:
when it is detected that the verification data corresponding to the requested object is not consistent with the storing file containing the requested object, updating the management information for the storing file which is not consistent with the verification data.

20. The method according to claim 4,
wherein the management information is stored on a memory in the terminal device.

21. The method according to claim 4,
wherein the management information is stored as a file in a file device provided in the terminal device.

22. The method according to claim 4,
wherein the storing file is stored in a file device provided in the terminal device.

23. The method according to claim 4,
wherein the management information and the storing file are stored in the terminal device on a directory-by-directory basis.

24. A computer program to be executed by a computer to achieve a method of browsing contents on a network in an offline mode of a terminal device, the method comprising the steps of:
receiving a request for an object designated by a URI (Uniform Resource Identifier);
reading out the requested object from a storing file, which stores a Web page containing at least one object, by using management information which is used to search for the requested object in the storing file using the URI as a keyword; and
displaying the requested object read out from the storing file.

25. The computer program according to claim 24,
wherein the storing file contains a plurality of objects,
wherein the management information includes for each of the plurality of objects:
(a) the URI of a target object;
(b) a file name of the storing file including the target object; and
(c) address information of the target object in the storing file,
wherein said reading out the requested object from the storing file includes:
searching the management information to obtain the file name of the storing file containing the requested object and to obtain the address information of the requested object; and
reading out the requested object from the searched storing file using the obtained file name and the address information.

26. The computer program according to claim 25,
wherein the management information further includes for each of the plurality of objects:
(d) one of a latest update time of the target object and an acquisition time of the target object,
wherein said reading out the requested object from the storing file includes:
selecting latest one from objects having the same URI corresponding to the requested object using the management information if two or more objects having the same URI corresponding to the requested object are stored in one or more storing files; and
reading out the latest one from the storing file using the file name and the address information concerning the latest one.

27. The computer program according to claim 25,
wherein the management information further includes for each of the plurality of objects:
(d) one of a latest update time of the target object and an acquisition time of the target object,
wherein said reading out the requested object from the storing file includes:
if two or more objects having the same URI corresponding to the requested object are stored in one or more storing files, displaying the file name and/or the acquisition time regarding the two or more objects so that a user can selects one of the two or more object; and
reading out one of the two or more objects selected by the user from the storing file using the file name and the address information concerning the object selected by the user.

28. The computer program according to claim 25,
wherein the management information further includes for each of the plurality of objects:
(d) one of a latest update time of the target object and an acquisition time of the target object,
wherein said reading out the requested object from the storing file includes:
if two or more objects having the same URI corresponding to the requested object are stored in one or more storing files, selecting one of the two or more objects, wherein the one of the two or more objects has the acquisition time nearest to the acquisition time of an Web page previously displayed before the requested object currently requested is designated by a user on the previously displayed Web page; and
reading out the selected object from the storing file using the file name and the address information concerning the selected object.

29. The computer program according to claim 25,
wherein the management information further includes for each of the plurality of objects:
(e) verification data which is used to verify that the storing file including the target object is not changed from a time when the storing file containing the target object is initially registered,
wherein said reading out the requested object from the storing file includes:
reading out the requested object only when it is confirmed that the verification data corresponding to the requested object is consistent with the storing file containing the requested object.

30. The computer program according to claim 29,
wherein the verification data includes at least one of a file size, a time stamp, a checksum and a CRC concerning the storing file.

31. The computer program according to claim 29,
wherein the verification data includes a message digest including one of an MD5 and SHA-1.

32. The computer program according to claim 24,
wherein the URI of the requested object is inputted by a user by a letter input through use of a user interface device.

33. The computer program according to claim 24,
wherein the URI of the requested object is designated by a user by an anchor selection.

34. The computer program according to claim 24,
wherein the storing file contains a single object,
wherein the management information includes for each of the plurality of objects:
(a) the URI of a target object; and
(b) a file name of the storing file including the target object.

35. The computer program according to claim 24, the method further comprising:
creating or updating the management information when the Web page is stored as the storing file.

36. The computer program according to claim 24, the method further comprising:
creating or updating the management information based on the storing file being stored when the terminal device changes from an online mode to the offline mode.

37. The computer program according to claim 25, the method further comprising:
creating or updating the management information when it is found that the storing file having the searched file name is not exist in actuality.

38. The method according to claim 24, the method further comprising:
detecting file operation regarding the storing file; and
creating or updating the management information in accordance with a type of the file operation,
wherein the file operation includes at least one of addition, update and deletion of the storing file.

39. The computer program according to claim 29, the method further comprising:
when it is detected that the verification data corresponding to the requested object is not consistent with the storing file containing the requested object, updating the management information for the storing file which is not consistent with the verification data.

40. The computer program according to claim 24,
wherein the management information is stored on a memory in the terminal device.

41. The computer program according to claim 24,
wherein the management information is stored as a file in a file device provided in the terminal device.

42. The computer program according to claim 24,
wherein the storing file is stored in a file device provided in the terminal device.

43. The computer program according to claim 24,
wherein the management information and the storing file are stored in the terminal device on a directory-by-directory basis.

44. A computer program product providing a set of instructions executed by a terminal device, the terminal device executing the instructions functioning as browsing contents on a network in an offline mode, the computer program product comprising functions of:
receiving a request for an object designated by a URI (Uniform Resource Identifier);
reading out the requested object from a storing file, which stores a Web page containing at least one object, by using management information which is used to search for the requested object in the storing file using the URI as a keyword; and
displaying the requested object read out from the storing file.

45. A terminal device, comprising:
an obtaining system that obtains a Web page through a network and stores at lest one objects contained in the Web page into a storing file;
a management information creating system that creates management information which is used to search for an object in the storing file using a URI of the object as a keyword;
a searching system that searches the management information to find a requested object designated by the URI and reads out the requested object from the storing file; and
a displaying system that displays the requested object read out from the storing file.

46. A terminal device, comprising:
an automatic accessing system that automatically accesses Web pages, which are designated in advance in an URI list, and stores the accessed Web pages into storing files;
a management information creating system that creates management information which is used to search for an object in the storing files using a URI of the object as a keyword;
a searching system that searches the management information to find a requested object designated by the URI and reads out the requested object from one of the storing files; and
a displaying system that displays the requested object read out from the one of the storing files.

47. The terminal device according to claim 46,
wherein the automatic accessing system is configured to access linked pages contained in the accessed Web page and to save the linked pages through the network as well as the Web pages listed in the URI list.

48. The terminal device according to claim 46,
wherein the automatic accessing system is configured to consult firstly the management information to determine whether the Web pages in the URI list is already exist in the terminal device,
wherein the automatic accessing system obtains each Web page through the network only when it is determined that the each Web page in the URI list does not exist in the terminal device.
